(19) United States
(12) Patent Application Publication
(10) Pub. No.: US 2024/0291359 A1
(43) Pub. Date: Aug. 29, 2024

(54) Method And Apparatus for Near-Net-Shape Fabrication Of Spray-Formed Components

(71) Applicant: Sumitomo Heavy Industries, Ltd., Tokyo (JP)

(72) Inventors: Brett Guralnick, Wakefield, MA (US); Jayaraman Krishnasamy, Boxborough, MA (US); Ankur Gupta, Wakefield, MA (US); Martin Hosek, Salem, MA (US)

(21) Appl. No.: 18/587,084

(22) Filed: Feb. 26, 2024

Related U.S. Application Data
(60) Provisional application No. 63/447,960, filed on Feb. 24, 2023.

(51) Int. Cl. H02K 15/02; B22F 7/02; C23C 24/04; H02K 1/02; H02K 1/14

(52) U.S. Cl. CPC H02K 15/022; B22F 7/02; C23C 24/04; H02K 1/02; H02K 1/146; B22F 2301/35; B22F 2302/253

(57) ABSTRACT

A method for spray-forming a component comprises spraying a soft magnetic composite material through a nozzle and into a mold; and adjusting a position of the mold relative to a position of the nozzle to control a deposition of the soft magnetic composite material into the mold. Adjusting the position of the mold relative to a position of the nozzle is carried out with mounting the mold on a stage such that the mold is movable relative to the nozzle and the spraying of the soft magnetic composite material is controlled to provide the deposition of the soft magnetic composite material to form the component in a near-net shape.

### CROSS REFERENCE TO RELATED APPLICATION

This application claims priority under 35 USC 119 (e) to U.S. Provisional Application No. 63/447,960, filed Feb. 24, 2023, which is hereby incorporated by reference in its entirety.

### BACKGROUND

### Technical Field

The example and non-limiting embodiments relate generally to processes of spray-forming soft-magnetic materials and spray-formed components formed by spray deposition of soft-magnetic composite materials.

### Brief Description of Prior Developments

Prior inventions described the production of soft-magnetic composite materials by spray-deposition of powder particles.

### SUMMARY

The following summary is merely intended to be exemplary. The summary is not intended to limit the scope of the claims.

In accordance with one aspect, a method for spray-forming a component comprises spraying a soft magnetic composite material through a nozzle and into a mold; and adjusting a position of the mold relative to a position of the nozzle to control a deposition of the soft magnetic composite material into the mold. Adjusting the position of the mold relative to a position of the nozzle is carried out with mounting the mold on a stage such that the mold is movable relative to the nozzle and the spraying of the soft magnetic composite material is controlled to provide the deposition of the soft magnetic composite material to form the component in a near-net shape.

In accordance with another aspect, a method for spray-forming a component in a near-net shape comprises providing a system for spraying a soft magnetic material, the system comprising a nozzle; providing a mold for receiving the sprayed soft magnetic material; spraying the soft magnetic composite material through the nozzle and into the mold at a beam spot; adjusting a position of the mold relative to the nozzle to control a deposition of the composite material at the beam spot to form the component in the near-net shape; and removing the component from the mold.

In accordance with another aspect, a system for making a component comprises at least one spray gun; a stage mounted proximate the at least one spray gun; and a mold mounted on the stage, wherein the mold is movable relative to the at least one spray gun and is configured to receive a spray of a material in powder form from the at least one spray gun into the mold to deposit a layer of material to form the component in a near-net shape.

In accordance with another aspect, an apparatus comprises at least one processor; and at least one non-transitory memory storing instructions that, when executed with the at least one processor, cause the apparatus to spray a soft magnetic composite material through a nozzle and into a mold; and adjust a position of the mold relative to a position of the nozzle to control a deposition of the soft magnetic composite material into the mold. Adjusting the position of the mold relative to a position of the nozzle is carried out with mounting the mold on a stage such that the mold is movable relative to the nozzle and the spraying of the soft magnetic composite material is controlled to provide the deposition of the soft magnetic composite material to form the component in a near-net shape.

In accordance with another aspect, a motor component comprises a spray formed disk having a first face, an opposing second face, and an edge surface extending between the first face and the opposing second face, wherein a hole having a defining surface extends through the disk from the first face to the opposing second face, and wherein the spray formed disk is formed in a near net manufacturing process.

### BRIEF DESCRIPTION OF THE DRAWINGS

The foregoing aspects and other features are explained in the following description, taken in connection with the accompanying drawings, wherein:

FIGS. 0A and 0B are side and perspective representations, respectively, of one example of a spray-formed material having a geometry defined by tapered edges;

FIG. 1 is a perspective view of one example apparatus used for spray-forming a near-net shaped component;

FIGS. 2A, 2B, 2C, and 2D are top views of the spray apparatus of FIG. 1 at different positions;

FIG. 3 is a schematic view of one example of a multiple station setup for spray-forming;

FIG. 4 is a perspective view of an example of a spray-formed disk shaped component;

FIG. 5 is a schematic view of a disk setup showing a disk mold assembly and spray gun direction;

FIG. 6 is a schematic view of a desired variation in angle of incidence of a particle beam with respect to a mold;

FIG. 7 is a graphical representation of build plate rotational direction and translation speeds;

FIG. 8 is a schematic view of a shape and placement of an air knife relative to a build plate;

FIG. 9 is a sectional view of radiused or chamfered edges on a spray formed component;

FIG. 10 is a process flow diagram showing an example mold fill and removal process;

FIG. 11 is a perspective view of one example of a disk-shaped component having a center void;

FIG. 12 is a perspective view of an example mold assembly including a center mold part;

FIG. 13 is a schematic view of angles of incidence of particle beams received at various points;

FIG. 14 is a process flow diagram showing one example of a fill and removal process for a cylinder near-net shaped component;

FIG. 15 is a perspective view of an example geometry of a stepped edge disk with a stepped center hole;

FIG. 16 is a process diagram showing an example of a deposition process and near-net shaped component removal for a stepped feature disk part with a stepped center hole;

FIGS. 17A and 17B are example geometries of rectangular parts and tapered edges on components;

FIG. 18 is a perspective view of a rectangular mold assembly with multi-part mold walls; and

FIG. 19 is a perspective view of a process of removing walls following the filling of a mold cavity.

### DETAILED DESCRIPTION

Described herein are techniques and apparatuses to enable spray deposition of magnetically isotropic soft magnetic composite materials to produce components in near-net form, the composite materials comprising a dense matrix of ferromagnetic domains separated by electrically insulating boundaries. Such soft-magnetic composite materials may be used in the fabrication of electric motors that use three-dimensional flux flow, which may be referred to as hybrid-field motors. The term “near-net” means that only the spray-facing surface is post-finished. Surfaces defined by the mold walls and build plate do not need post-finishing. The amount of material to be removed through post-finishing is approximately 1 millimeter (mm) or less. As a percentage of the material removal, thicker components have a lower percentage of material removal. Fabrication of stators and stator components having various geometries in near-net form may eliminate the need for expensive, complicated, and time-consuming post-machining operations. Various materials and methods for the fabrication of such motors are disclosed, for example, in U.S. Pat. Nos. 10,622,848; 10,170,946; and 9,887,598; and in US Patent Publication No. 2016/0197523, all of which are incorporated by reference herein in their entireties. With regard to processes of spray-forming, U.S. Pat. No. 9,205,488 describes a soft-magnetic material produced by a spray-forming process, and US Patent Publication No. 2013/0000860 describes a spray-forming process based on layered particle deposition, both of which are incorporated by reference herein in their entireties.

Spray-forming (also referred to as spray-deposition) involves depositing particles at high temperatures and speeds onto a base plate to produce a soft-magnetic composite material. Spray-forming directly onto a build plate 10 results in material geometry with tapered edges 12, as shown in FIGS. 0A and 0B, such that the deposited material 14 may need to be post-machined to a final desired geometry. To avoid post-machining, which is expensive and time-consuming, it is desirable to produce the desired shapes in a near-net manner. Examples of desired shapes include, but are not restricted to, ring and rectangular shaped parts.

The example embodiments described herein achieve fabrication of spray-formed parts in a near-net manner through the use of molds. In order to achieve the fabrication of such parts:
1. Spray deposited material completely fills a mold cavity. A 100% fill of the mold cavity (no voids) is desired.
2. The mold design should allow for at least one open face through which the material can be spray-deposited.
3.After deposition, the filled material may be released from the mold in a manner that allows the mold to be reused.

The following aspects of near-net shape fabrication using molds are described herein:
(a) design of mold geometry;
(b) selection of mold material;
(c) material deposition into a mold cavity; and
(d) methods to release, separate, and reuse the molds.

The example embodiments described herein, in practice, involve the deposition of powder with a core-shell structure via a high velocity air fuel (HVAF) thermal spray gun. Such powders may be, for example, iron or soft iron alloy, such as iron-base alloy, iron-cobalt alloy, nickel-iron alloy, silicon iron alloy, iron-aluminide, ferritic stainless steel, or similar type alloy, coated with electrically insulating material preferably comprising at least one ceramic-based material, such as alumina, magnesia, zirconia, or the like. The methods described herein may apply to other types of powders as well and may be used with other types of delivery systems. The deposition process involves the following:
(a) A series of repeating scanning motion of the point of incidence of the particle beam on the deposited material. This repeating scanning motion is also referred to as a spray pass.
(b) Variation of angle of inclination of the particle beam with respect to the deposited material.
(c) Measure and monitoring of thickness of the deposited material.

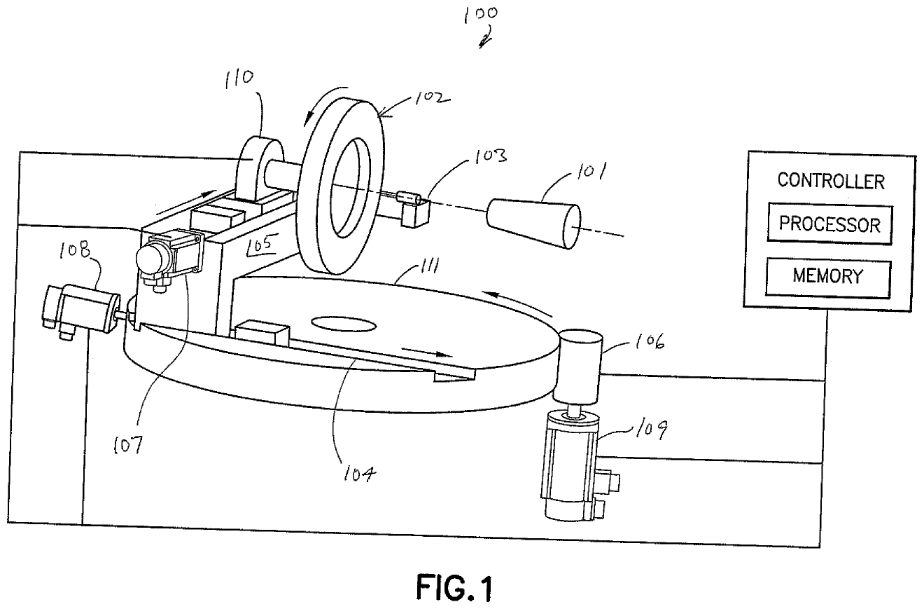

Referring to FIG. 1, one example of an apparatus for depositing such materials is shown at 100 and is hereinafter referred to as “spray apparatus 100.” Spray apparatus 100 is used to create axi-symmetric near-net shaped parts and comprises a spray gun 101 having a nozzle, a build plate having a mold 102 attached thereto, and a cooling device 103. The build plate and the mold 102 are mounted on a stage 111 and are rotatable about a Φ-axis of rotation. At least one of the spray gun 101 and the mold 102 are movable about three independent axes. The spray gun 101 deposits the metal powder onto the mold 102. The cooling device 103 is located at a fixed position relative to the mold 102. The movement of the mold 102 is carried out using an X-direction motor 107 to drive an X-slide 105 while simultaneously rotating the build plate and mold 102 about the Φ-axis of rotation with a motor 110. A solid material is formed by spraying material from the spray gun 101 in repetitive passes until a desired thickness has been reached. Following each pass, the distance from the spray gun 101 to the deposited material interface can be held constant by translating the mold 102 in the Y-direction on a Y-slide 104 by driving a Y-direction motor 108. To spray into the mold cavity corners, a θ-axis can be rotated with the θ-direction motor 109.

During the deposition process, the X and Y stage positions are adjusted to ensure the point of incidence of the particle beam on the part surface coinciding with the theta axis of rotation.

Movements and positions of the spray gun 101 and/or the mold 102 may be controlled by a controller having at least one processor and at least one non-transitory memory storing instructions, that when carried out by the processor, cause operations that effect the movement of the spray gun 101 and/or the mold 102. Movement of either or both the spray gun 101 or the mold 102 may be carried out by controlled operations of the motors. The cooling device 103 may also be controlled using the processor, memory, and instructions.

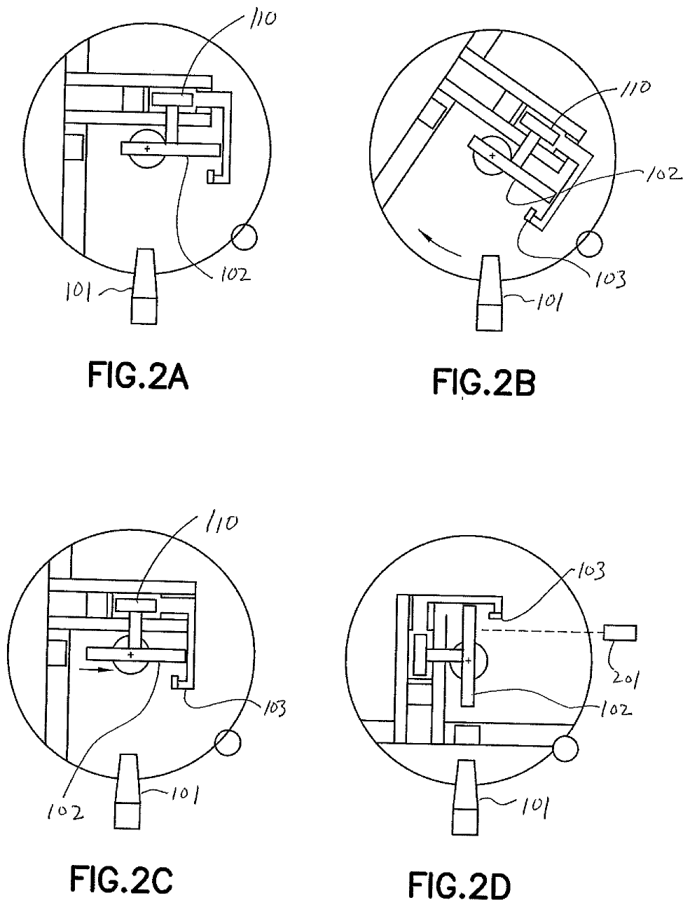

Referring now to FIGS. 2A, 2B, 2C, and 2D, top views of the spray apparatus 100 are shown at different theta positions. The point of incidence of the particle beam on the part surface is on the axis of rotation of the theta stage. To fill corners without introducing voids, the build plate and the mold 102 are rotated around the θ-axis as shown in FIG. 2B. Translating the X-position as shown in FIG. 2C continuously exposes a new position on the mold 102 to the particle beam. When not filling mold corners, the θ-rotation is set to zero degrees (normal to spray path) to maximize the material adhesion. Throughout the entire spray operation, the build plate is spinning (Φ-axis 110) to maintain a uniformly axisymmetric part. The spin also enables uniformity in cooling using an air-cooling fixture 103 which maintains a constant position regardless of the X, Y, or θ-rotation. The deposited material thickness can be measured using a distance sensor 201 zeroed at the build plate face. The Y-slide plate 104 is rotated, set at 90 degrees as shown, until the build plate and mold 102 are facing the distance sensor. Following the thickness measurement the device rotates back to the initial setup, as shown in FIG. 2A, for subsequent material deposition.

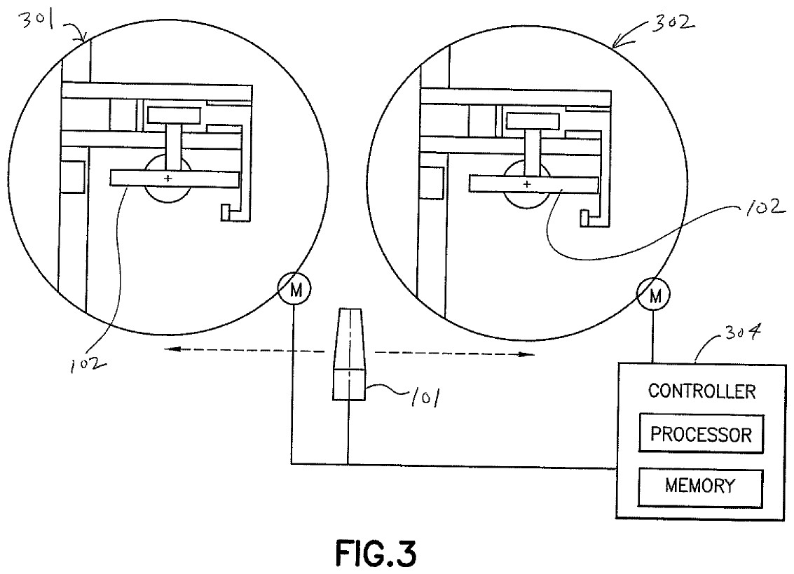

Referring now to FIG. 3, a multiple station setup is shown. A single spray gun 101 can produce multiple near-net shaped components with parallel stations. A first station 301 is side by side with a second station 302. However, it is possible to increase the number of stations to three or more. The spray gun 101 translates from station 301 to station 302 to fill the mold(s) 102 in a sequential manner. Computer-based control monitors and adjusts the temperature, material thickness, motion trajectory, and run status to ensure repeatability and quality metrics. The computer-based control is shown at 304 and may include at least one processor and at least one non-transitory memory storing instructions that, when executed with the at least one processor, carry out spraying and movement operations. Movement operations may be carried out by control of the motors M.

An alternate apparatus may be employed in which the mold 102 spins about a stationary axis and the spray gun 101 moves to accomplish the desired spray beam translation and inclination. One example implementation is to mount the spray gun 101 to a multi-axis robot. The robot enables simultaneous scanning and tilt, as well as motion towards or away from the mold 102. In a multi-station setup, the robot also enables motion from one station to the next.

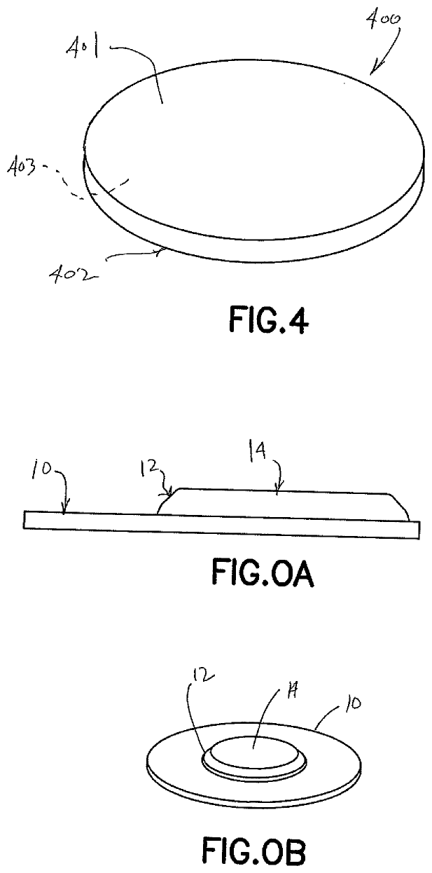

Methods of forming near-net shaped parts involve mold design and filling of molds and are described below. FIGS. 4, 11, 15, 17A, and 17B illustrate examples of final near-net shaped components using the methods described herein.

### Mold Design

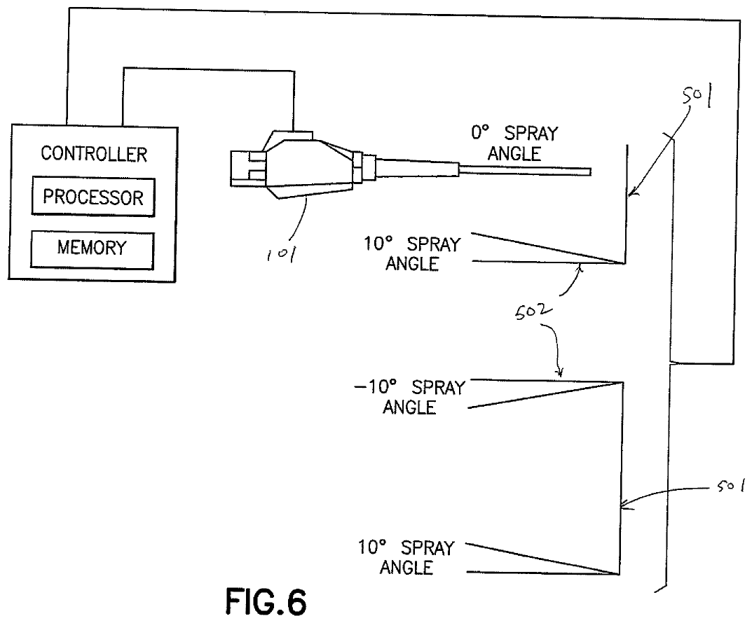

Mold design involves design of mold geometry, selection of mold material, and selection of optimal mold surface characteristics.
(a) Mold geometry: A mold is an assembly of two basic components: a mold build plate and mold side wall components. The build plate faces the incoming particles from the spray deposition system. The mold side walls define the profile of the desired geometry. For example, to produce a cylindrical ring-shaped part, a mold comprising a build plate and an outside wall may be used. In some embodiments, an inside plug may be used (see FIGS. 12, 13, 14, and 16). The volume defined by the outside wall, the inside wall, and the build plate surface represents the mold volume that is filled.
   Wedging action of high velocity incident particles result in compressive stresses in the spray formed material. The compressive stress, in turn, results in a positive contact pressure on the mold wall. The mold wall, if made of a lower strength material such as aluminum, should have adequate thickness to resist the compressive stress.
(b) Mold surface characteristics: To achieve 100% fill of the mold volume, the mold surface should meet two requirements. (i) The mating surfaces need a high degree of flatness to avoid gaps between surfaces. Gaps between mating surfaces, due to surface roughness, impurities, or scratches may result in voids in the mold fill volume. (ii) The second requirement is the avoidance of edge radii and chamfers. The incident particle beam cannot reach the space under chamfers and radii, resulting in voids. Generally, mold surfaces in contact with each other are machined to a surface flatness of 0.005 inches (in.) or better. Machining practices to avoid edge chamfers and corner radii are adopted in producing the mold. Mold surface may be grit blasted. The desired level of bond strength between material and mold surface can be achieved through grit blasting.
(c) Mold materials: The selection of material for the build plate and side walls is based on multiple criteria. The materials for the mold are selected as follows. The build plate component is low carbon steel, and the mold outer wall is aluminum. The low carbon steel material is selected due to the limited adhesion strength between the deposited material and the steel.
   Build plate: One factor in selection of build plate material is the bond strength between the build plate and the deposited material. A low bond strength is desired to enable release of the mold after deposition. For this reason, the build plate is made of high strength steel. On the other hand, too low a bond strength leads to premature delamination. Bond strength is proportional to the extent of penetration of the high-velocity particles into the mold surface as well as the particle temperature. To limit penetration, the build plate, whose surface directly faces the impinging particles, is made of a high strength material such as steel. On the other hand, grit blasting of the build plate to increase surface roughness leads to higher bond strength.
   Mold wall: In contrast to the build plate, impinging particles meet the mold walls at a shallow angle (FIG. 6) and do not have adequate momentum to penetrate the wall surface. Therefore, mold walls can be made of lower strength materials such as aluminum without the risk of particles penetrating the mold. An advantage of using aluminum is that the thermal expansion difference between aluminum and the sprayed material is great. One approach to releasing the mold wall is to use the difference in thermal expansion to relieve the contact pressure between the mold wall and the spray-formed material. To facilitate this, the mold wall material should have a higher thermal expansion coefficient than the spray-formed material. Since aluminum has a higher thermal expansion coefficient than ferrous materials, aluminum is an ideal material for the mold wall.

### Axisymmetric Near-Net Shaped Disk

### Deposition in Mold

The following outlines the near-net shape deposition of a spray-formed disk shaped part 400. FIG. 4 details the disk part geometry, which includes two opposing top and bottom faces. The top face is 401, and the bottom face is 403, which are separated by a vertical wall 402 defining a cylindrical outer diameter. The top and bottom faces 401, 403 are substantially flat and parallel. Parts of other shapes are possible.

In other examples, the spray-formed motor component may be a yoke for a stator for a motor. Such a stator comprises a housing having coils, stator teeth (formed of an isotropic soft-magnetic composite material, for example), and the backing ring or yoke, as described herein. A bearing sleeve extends into the housing. Motor bearings are contained in the bearing sleeve, which is removable and replaceable. This helps with motor maintenance. In particular, radial bearings and thrust bearings are mounted in the bearing sleeve to facilitate the rotation of a rotor relative to the stator. A space is formed in the housing to accommodate the routing of interconnecting wires. The coils are pre-formed copper wires that are pressed to maximize copper density and are inserted over the stator teeth before interconnection.

The disk shaped part 400 or spray-formed disk 450 cannot be fabricated by spraying directly onto a build plate surface. The deposited materials form a sloped edge wherever the deposition stops. An example of the sloped edge formed on the build plate is shown in FIGS. 0A and 0B.

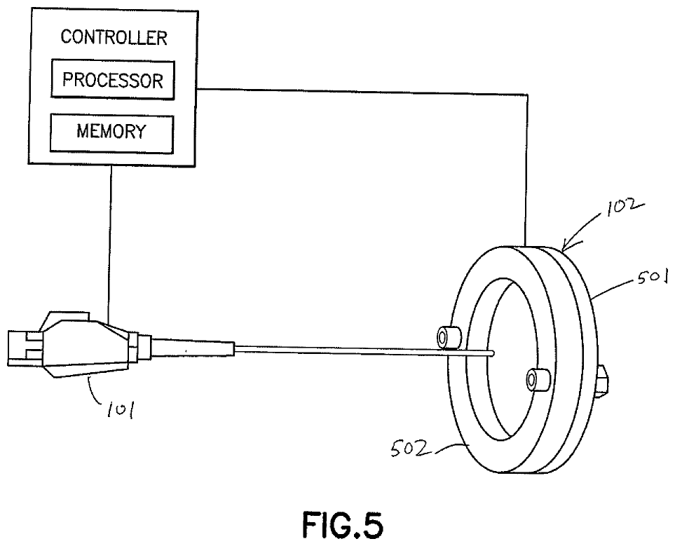

To produce the disk shape, a mold comprising a build plate and an outer wall is assembled on a rotating fixture. The powder spray is aimed into the open face of the mold. At least the spray gun 101 and movement of the mold may be controlled using a controller having at least one processor and at least one non-transitory memory storing instructions that, when executed with the processor, cause the operations of the spray gun 101 and movement of the mold (as well as any cooling). A schematic of the disk setup is shown in FIG. 5.

As shown in FIG. 5, an example of the mold 102 may comprise a build plate 501 and a mold outer wall 502. The powder spray beam from the spray gun 101 deposits material into the mold cavity. To achieve a complete fill, a variable trajectory is used, as shown in FIG. 6.

The mold assembly or mold 102 comprises multiple parts. The near-net shaped disk mold uses two components. The first, the build plate 501, made from low carbon steel, is fastened to the mold outer wall component, made from aluminum, as shown in FIG. 5. In one example, these two components are fastened with two or more nut and bolt assemblies, positioned axially uniform to promote even clamping force around the mold outer wall. The torque of each fastener is set to about 30 lb-ft (pound-feet). The aluminum mold wall is sufficiently thick such that the material does not deform when compressive stress from spray-forming is applied to the mold walls.

Prior to mounting the mold assembly, the components are grit blasted while fastened together with aluminum oxide grit, for example, mesh size 40-140, to aid in adhesion. The mold component material is selected to enable part removal from the mold 102. The details are explained in further detail in the “removal from mold” section.

Selection of steel material for the build plate component may present an adhesion challenge. To overcome the low adhesion strength between the steel build plate and the deposited material the first layers may be deposited without any cooling to increase adhesion. Up to ten uncooled adhesion passes may be used, the most common being five passes. Directly following the uncooled adhesion passes a series of passes with a tapered temperature profile may be deposited until the continuous process setpoint is reached. In this example, once the temperature has been tapered to about 190 degrees C., the standard temperature control scheme drives the process.

Referring to FIG. 6, the motion sequence for fabricating the disk shaped part 400 may be split into two components: (1) The motion of the spray gun 101; and (2) the motion of the mold 102. For the motion of the spray gun 101, a six-axis robot may be employed, such robot being controlled by a controller having at least one processor and at least one non-transitory memory storing instructions, that when carried out by the processor, cause operations of the robot. The robot transverses a linear path parallel to the build plate 501 and enables changing the spray angle up to, e.g., 45 degrees From the build plate 501. The angle can be in any orientation relative to zero degrees which corresponds to spraying directly normal to the build plate 501. The movement of the mold 102 may also be controlled by the controller, e.g., through control and operations of motors. The spray angles used at the vertical walls are shown in FIG. 6.

As shown in FIG. 6, a desired variation on an angle of incident of particle beam with respect to a mold 102 to fill inside corners of the mold 102 is shown. The spray deposition process utilizes precise control of the point of incidence of the particle beam (“beam spot location”) and orientation of the beam with respect to the mold (“beam orientation”). Precise control of the beam spot location and beam orientation is accomplished by mounting the spray gun 101 to a servo controlled 6-axis robot arm or by fixing the spray gun location and translating/rotating the mold assembly as described with regard to the apparatus 100 of FIG. 1. In addition, the mold 102 may be mounted on a rotating platform. The beam orientation angle of 2-20 degrees (typically 5-10) is used near the mold walls and 0 degrees at regions away from the mold walls. To produce axisymmetric parts (such as parts with cylindrical surfaces), the mold 102 is mounted on a platform that rotates about the axis of symmetry, and the beam spot is traversed along a linear radial or close to radial path.

An angle of 5-10 degrees may be used at walls parallel to the path of the spray gun 101. This angle helps reduce the amount of robot travel or mold travel and enables the best possible adhesion of the sprayed material to the build plate, which is at a maximum when the spray angle is zero degrees. When spraying on a joint formed between two or more walls, the spray gun 101 is controlled so as to spray the soft magnetic composite material to form a joint radius that is less than the size of an individual particle of the soft magnetic composite material. The spray gun 101 (as well as other spray devices disclosed herein) may be controlled using a controller having at least one processor and at least one non-transitory memory storing instructions that, when executed with the processor, cause the apparatus to perform various operations.

For round parts which have axial symmetry, such as the disk, the mold assembly or mold 102 is continuously rotated about the axis of symmetry. The robot moves the spray gun 101 synchronously in a linear path to fully deposit material in the mold cavity. The mold assembly or mold 102 rotational speed and the linear rotational speed are coupled so the beam spot velocity with respect to the build plate face is fixed at, e.g., 600 mm/s (millimeters per second). Additionally, or alternatively, the mold 102 may be moved by itself or synchronously with the spray gun 101, as in the spray apparatus 100.

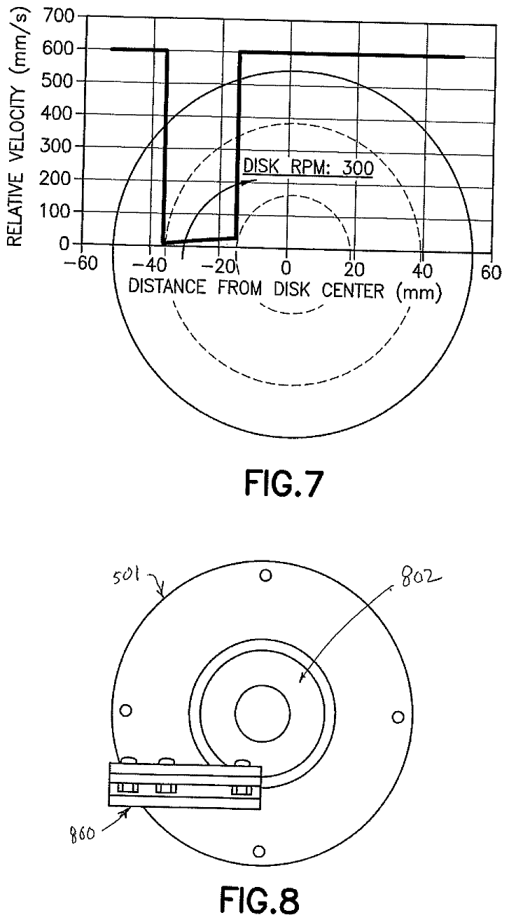

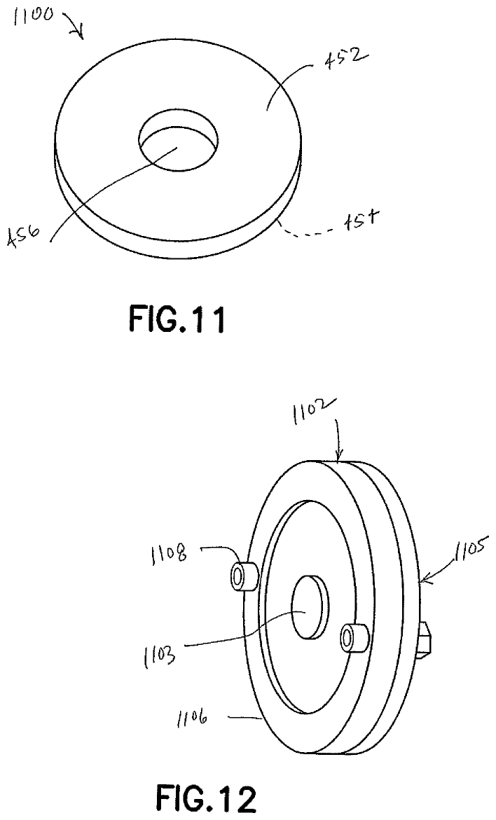

FIG. 7 shows the build plate rotational direction and the translation speeds used. The beam spot velocity may vary by plus or minus fifty percent during the fill operation to optimize the deposited material temperature. FIG. 7 is an example of desired scanning speed of point of incidence of particle beam with respect to mold center to produce a disk shaped part 1100 as shown in FIG. 11. In this example, the disk is spinning at 300 rpm (revolutions per minute) and the desired relative surface speed is 600 mm/s.

In any embodiment, the temperature of the deposited material may be controlled using a computer algorithm that starts each deposition pass once a given temperature has been reached. As an example, a non-contact infrared pyrometer may be utilized to measure the temperature. The mold assembly or mold 102 may be pre-heated to, e.g., 300-325 degrees C. before the deposition operation starts to ensure the mold temperature is consistent throughout deposition process. The high velocity combustion gas from the nozzle may be used as the source of heat. The rate of heat input may be adjusted by adjusting distance between nozzle and mold surface. The temperature may continually increase during the material deposition process due to the hot particles adding to the material and the combustion reaction flame positioned directly over the mold assembly during deposition. Each deposition pass may begin when the mold assembly has cooled to, e.g., 190 degrees C. to ensure pass-to-pass consistency. To control the maximum temperature of the mold assembly or mold 102, the robot translation speed may be adjusted to control the deposition time of each pass. The maximum temperature setpoint may be set to, e.g., 350-400 degrees C.

The mold assembly and deposited material can be cooled with different processes. Two of these processes are described herein. The first process uses the compressed air from the spray gun 101 to cool the mold assembly. The spray controller stops powder flow and turns off the fuel source. The compressed air source remains on while the robot moves the spray gun 101 along the same motion path to cool the assembly. This approach may use a significant amount of time to complete a part. The second process utilizes a secondary cooling source. Compressed air jets either from point sources or linear air knife edges are pointed toward the mold assembly. The amount of cooling can be controlled by varying the opening cross section, the air feed pressure, and the distance the air jet is located from the mold assembly. There are a large number of cooling settings that would work. In one example embodiment, the settings used are: 40 psi (pounds per square inch) inlet pressure, ten-foot half inch hose, and a three-inch air knife with a 0.006 inch opening, positioned half an inch below the mold center line and about two inches from the build plate face. The shape and placement relative to the build plate is shown in FIG. 8.

FIG. 8 is directed to an air knife cooling of the deposited material and build plate 501. This Figure shows the location of an air knife 800 used to cool the deposited material, shown at 802. The temperature of the mold assembly or mold 102 and the deposited material reaches up to 450 degrees C. during the spray-forming process. As the temperature rises, the mold wall 502, made of aluminum, tends to expand more than the deposited material. To prevent separation of the material from the mold 102 during the deposition process, it is desired to maintain a positive surface contact pressure at the mold walls 502. To ensure there is adequate contact pressure, the mold 102 is preheated before beginning deposition of the material. In addition, the mold walls 502 are bolted to the build plate 501 with adequate clamping force.

The squareness of the edges and mating faces allows for the achievement of a near-net shaped part without any material exclusions or voids. The flatness of the mating faces connecting the build plate and the outer wall of the mold should be less than 0.005 inch. Any roughness or imperfections in the surface can cause the two faces to have regions where the faces do not touch, which may lead to the formation of voids. The mating faces should remain smooth (roughness less than 0.005 in.) even following grit blasting. Therefore, fastening the mold assembly prior to any processing is desired. In addition to flatness, sharp edges should be formed between the mold assembly parts. A radius or a chamfered edge creates a volume under the mold that cannot be accessed by the deposition process. The material may not properly fill the volume with a radius or chamfer present. A void will form which the spray material will not be able fill.

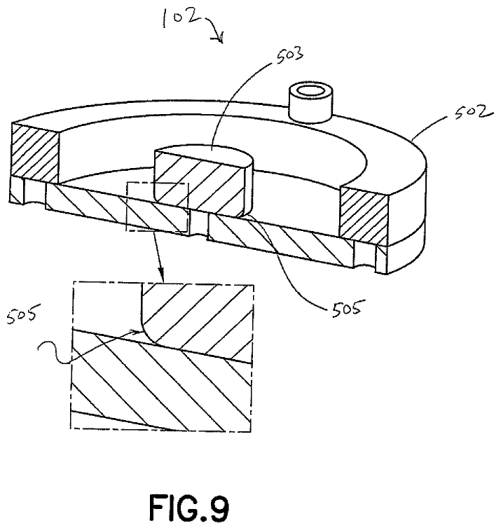

FIG. 9 is an example of radius or chamfer edges that lead to voids. As shown, the outer mold wall 502 depicts sharp edges and ideal mating surfaces which are preferred for a void free near-net shape. A central mold part 503, not used for a disk part, is shown with a radius 505 that causes the spray-formed material to be incomplete when depositing material. When radius or chamfer edges are present a material void may manifest. Voids may also occur when the corners are edge broken. Square or sharp edges are used to achieve a desired spray-formed part. The exact radius tolerable is unknown.

The deposition thickness may be controlled with two different methods. In the first method, sacrificial material may be sprayed to calibrate the deposition rate or material growth per pass. With the deposition rate the number of passes required can be calculated. The second method uses a distance or displacement sensor which may be zeroed on the build plate face prior to deposition and then used to periodically measure the total deposition thickness.

### Removal from Mold

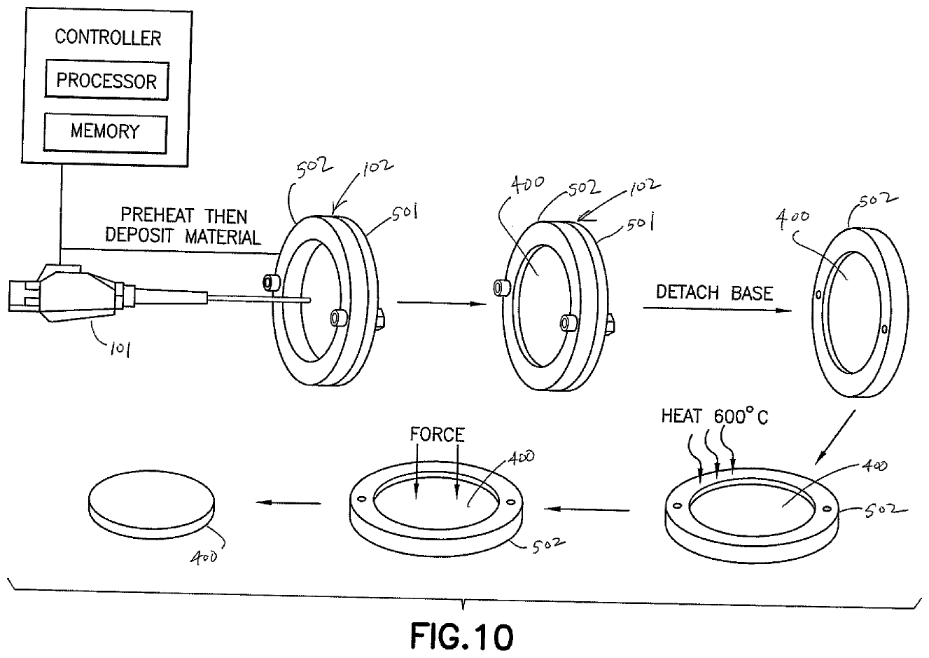

Referring now to FIG. 10, upon completion of the material being deposited in a multi-pass operation using the trajectory described in FIG. 6, the material is removed from the mold 102. Prior to deposition, the mold assembly of the build plate 501 and the mold walls 502 are pre-heated to increase material adhesion and prevent thermal shock from the hot particles. Once a desired part thickness is achieved, the mold walls 502 and build plate 501 are removed from the spray apparatus 100. The build plate 501 is detached from the mold walls 502. The part is heated to remove the part from inside the mold walls 502. The heat causes the mold walls 502 to expand more than the part due to the difference in thermal expansion between the two materials. Following the heating the part can be removed from the mold 102.

Upon completion of deposition of the material into the mold formed by the build plate and mold walls, the material is in compression, due to particles wedging into the material, and the build plate is in tension. Upon removing the mold assembly fasteners (502), the stress in the build plate is relieved, causing it to detach from the material which remains in compression due to the mold wall. To aid the removal of the build plate component from the mold assembly, a small mechanical force may be applied between the build plate 501 and the mold wall 502 interface. Another requirement for this process to work is that the adhesion force holding the sprayed material onto the build plate 501 is weaker than the strength of the deposited material. If this condition is not satisfied, then the separation will not occur at the interface but rather within the deposited material.

Once the build plate 501 has been removed, the mold wall 502 is separated from the spray-formed material. Depositing the material with a thermal spray operation causes the material to be under compressive stress due to the particles wedging into the material during deposition. This stress holds the material tightly inside the aluminum mold. It may be possible to apply a large force with a press and remove the deposited material from the mold 102; however, doing so may cause the material to facture before the part is released from the mold 102.

Instead, it is possible to take advantage of the difference in thermal expansion between the material of the mold wall 502 and the deposited material. Aluminum is generally selected for the mold walls 502 as the thermal expansion coefficient is roughly double the sprayed material (23.3 μm/m-C versus 12.0 μm/m-C, respectively). Heating the combined mold wall 502 and the deposition material to 600 degrees C. causes the aluminum to expand more than the deposited material. While the mold 102 is expanded the deposited material shaped like a disk (e.g., disk shaped part 400) can be directly removed with little to no force applied, as shown in FIG. 10.

A near-net shape dimensional variation of 0.005 in. or less can be achieved through tight tolerancing of mold dimensions. Lower dimensional variation can be achieved by under sizing the mold 102 to account for the expansion that occurs when the mold temperature rises during the deposition process. The core-shell material delaminates with nearly no residual deposition on the mold surfaces which allows the molds 102 to be reused for repeat parts.

### Axisymmetric Near-Net Shaped Disk With a Center Hole

An extension of the near-net disk shape is the same cylindrical shape but with the inclusion of a cylindrical void or a ring with square edges. FIG. 11 shows the desired part geometry of a such a spray-formed part 1100, which may be a motor component, having a ring-shaped void. The spray-formed motor component 1100 may be a spray-formed disk having a first face 452, an opposing second face 454, and a hole 456 in the center of the disk and extending through the disk from the first face 452 to the opposing second face 454. A motor component such as the spray-formed disk motor component 1100 may be formed in a near net manner.

Referring now to FIG. 12, a mold assembly or mold 1102 is similar to the mold 102 for a disk shaped part 400 previously described; however, an additional part in the form of a plug or a center mask 1103 is fastened to the build plate 1105. The mold build plate 1105, mold wall 1106, and the mold center plug 1103 are separate and may be different materials. The typical build plate material is low carbon steel, and the mold pieces (e.g., the mold wall 1106) are aluminum. The mold wall 1106 is held to the build plate 1105 with fasteners 1108. To ensure proper tolerance, an alignment jig or indexing pins can be used to assemble the mold wall 1106 to the build plate 1105. The mold assembly is fastened prior to grit blasting the surfaces, as was done previously. Additionally, all previous details regarding flatness and edge sharpness for the center mask 1103 are followed.

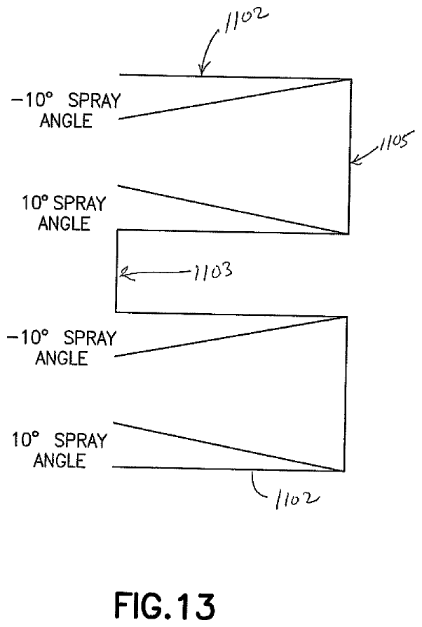

Referring to FIG. 13, in one example method of forming the part 1100, a trajectory change is made with the spray gun path. The addition of the mold center mask 1103 involves an extra angle transition at the wall of the center mask 1103. There may be a minimum distance between the mold outer wall and the mold center plug wall defined by the spot size of the spray beam and the height of the mold. The distance is larger than the sum of the spot size and the tangent of the spray angle times the height. All other spray operations are performed the same as for the disk shaped part.

Still referring to FIG. 13, a desired angle of incidence of the particle beam at various points of incident of the particle beam to adequately fill the inside corners of a mold 1102 with the center mask 1103 is shown. This is an extension to the spray angle outlined with regard to previously-described embodiments. The same or a similar procedure is used for the vertical walls of the plug (center mask 1103) as the inner surfaces of the mold wall 1106. The spray transitions from a negative angle at the mold walls 1106, to a zero degree angle when directly depositing on the build plate 1105, then transitioning to a positive angle when spraying along the walls of the center mask 1103.

The mold removal process is nearly identical to that of the disk without the center mask 1103 except for the following process change. Following the removal of the steel build plate 1105, the center mask 1103 should be removed next. The removal process also takes advantage of the difference in thermal expansion. The material of the center mask 1103 is aluminum. To remove the center mask 1103, the mold and deposition assembly are heated to 600 degrees C. The heated assembly is removed, then selectively cooled at the center mask 1103. The cooling can be achieved using ice, dry ice, liquid nitrogen, or another targeted cooling apparatus. Multiple temperature cycles may be used due to the center mask 1103 cooling conducting heat from the spray material. Once the entire face of the center mask 1103 has been released from the deposition spray, removal should require little force.

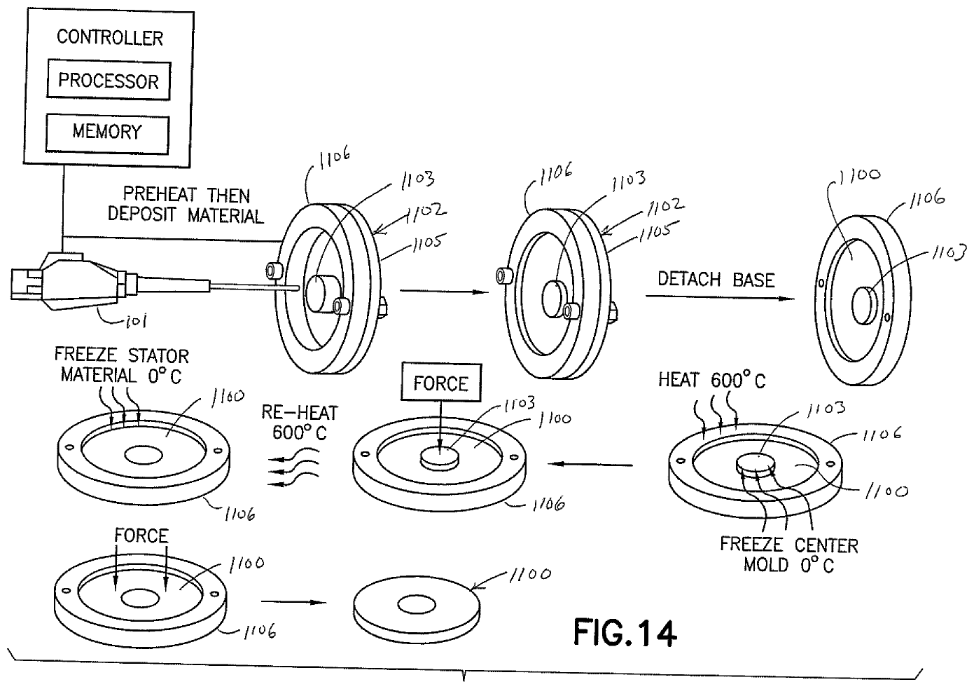

A process flow diagram is shown in FIG. 14. Here, a mold fill and a removal process for a cylinder near-net shaped part, such as part 1100, is shown. This Figure is similar to FIG. 10, with the disk-shaped mold incorporating a center void in the near-net shaped part. The additional procedure to remove the center mask 1103 creating the material void is also outlined. The fill operation proceeds the same as FIG. 10 utilizing the practices outlined in FIG. 13. To remove the center mask 1103, a combination of heating and cooling is used. The entire sample is heated to expand the components, then selective cooling is applied to the center mask 1103 to shrink the size of the center mask 1103. Once the center mask 1103 has shrunk, a force can be applied to press the center mask 1103 from the mold center. The other operations are performed in the same manner as outlined in FIG. 10. Axisymmetric near-net edge shape stepped disk with a stepped center hole:

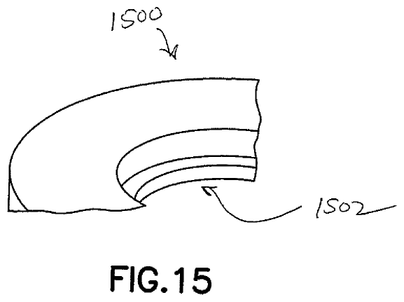

A near-net shaped part 1500 with two different diameters is described with reference to FIG. 15. The shape is similar to the part 1100 with center void. In particular, a stepped edge disk with a stepped center hole 1502 is shown.

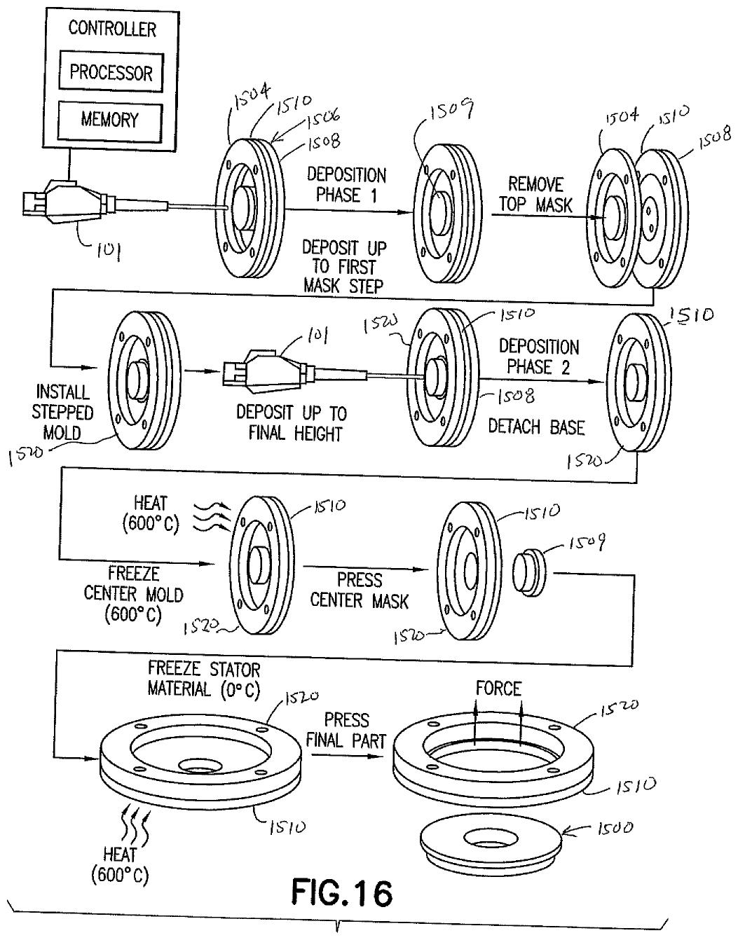

Referring to FIG. 16, a two-phase deposition and the mold removal process for the stepped part 1500 is shown. There is an increased complexity of the near-net part 1500 compared to previous parts. Part 1500 has multiple inner and outer diameters as a function of the part height. Complex part features use a multi-step process utilizing a series of molds. This is a desirable feature for parts with surfaces which transition from parallel to perpendicular with respect to the direction of the incident particle beam. The multi-step process of making part 1500 ensures the build always originates from the initial build plate. A continuous solid is desirable for spray-formed parts using molds. Voids and discontinuities in the deposited material may lead to poor material performance.

In making part 1500, the initial deposition process is similar to the disk with center void described previously. A mold assembly or mold 1506 comprises a build plate 1508 and a mold wall 1510 with a center plug 1509. However, in an example process of making the part 1500, a mask 1504 with the same dimensions of the mold wall 1510 and the center plug 1509 is placed on top of the mold wall 1510 and the center plug 1509. FIG. 16 shows the mold 1506 and mask 1504 in the first row of the process flow diagram. Previously, the mold height was not critical so long as the mold height was greater than the final part height. However, for the stepped mold, the first layer mold height should be the same as the target height for the part feature. The material deposition fills the mold cavity until the material reaches the top of the mold but is below the mask 1504. The mask 1504 shows the mask used in step 1 of the flow diagram of FIG. 16. The mask 1504 may be a sheet of metal such as aluminum or the like. The mask 1504 protects the spray-facing surface of the mold wall 1510 so that a second mask 1520 can be installed.

Once the material has filled the cavity, the parts of the mask 1504 are removed from the mold 1506 and the second mask 1520 with the stepped larger diameter is installed. The material is filled beginning with the smallest diameter and proceeding to the largest of the larger diameters to ensure continuity. Following the installation of the second mask 1520 the same fill procedure can be used by changing the spray path trajectory positions to match the larger dimensions.

Manufacture of this part involves stoppage mid-deposition to change out the mold components. Following the change of mold components, the mold material is grit blasted. Additionally, when restarting the material deposition process the mold 1506 is reheated using the same procedure as the initial deposition before resuming deposition. However, the adhesion passes are not used for the restarted spray.

The mold removal procedure is nearly identical as the disk with center void. The primary difference is the mold material has a directional component and can only be removed in one direction. The stepped face prevents the mold from being removed in either direction, as was possible with previous molds. Additionally, it may be desirable to cool the deposited material to aid in removing the mold outer wall.

### Rectangular Near-Net Shape

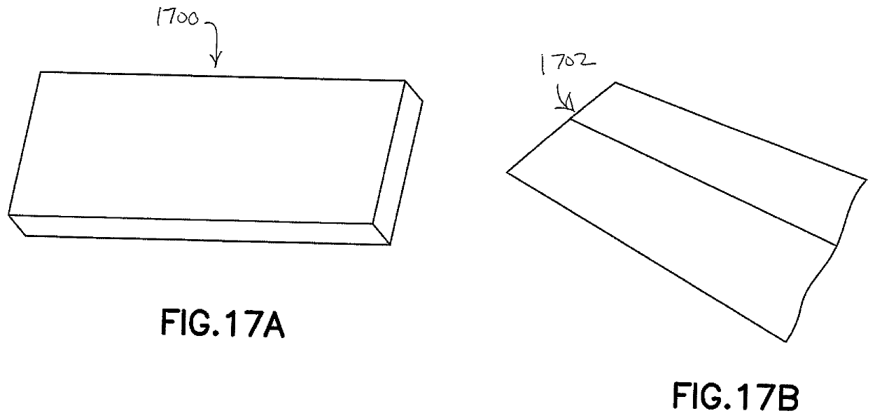

The next section describes the near-net fabrication of a rectangular part 1700 using the spray deposition technique. The goal shape is shown in FIG. 17A. Creating sharp vertical corners with thermal spray may present a challenge. Spraying directly onto a build plate with no mold walls causes the edges of the spray volume be sloped or tapered. An example of the tapered edge 1702 is show in FIG. 17B.

To overcome the edge taper a mold assembly or mold 1802 can be used, similar to the round shapes previously described. There are two different approaches when dealing with straight edged parts. The first is the use of split multi-part molds and the second, described previously, is the use of single part mold for each height change. This section describes the split multi-part mold assembly.

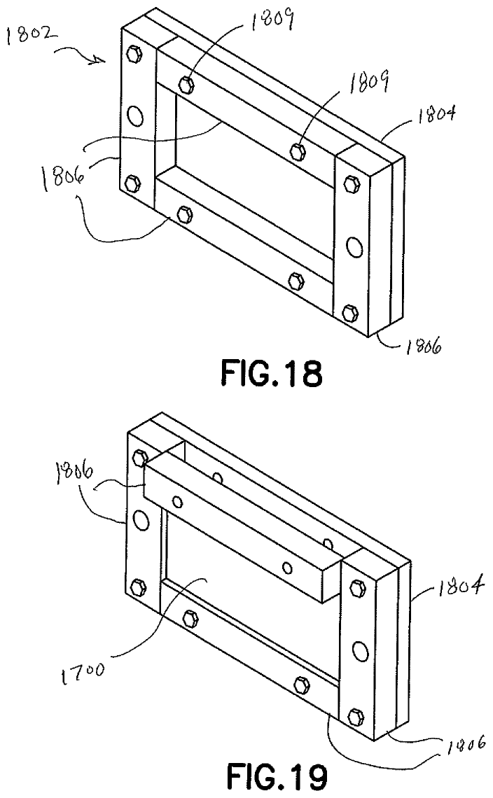

Referring to FIG. 18, a rectangular mold assembly or mold 1802 with multi-part removable mold walls is shown. The split multi-part mold 1802 comprises a single part build plate 1804. The material selected for the build plate 1804 is low carbon steel. Walls 1806 of the mold are built of individual parts for each edge. Since the walls 1806 are not one continuous piece it is possible to select multiple different materials for the walls 1806. Low carbon steel and aluminum are typically selected.

Each of the walls 1806 is fastened to the build plate 1804 using fasteners 1809 and with proper torquing. If any part moves during the deposition process, the final form may be incorrectly sized. Additionally, any gaps between parts may cause a material void. The faces and edges should have the same flatness and radii control outlined in the near-net shaped disk section.

Once the parts of the mold 1802 are properly fastened, the assembly is grit blasted and mounted on a stationary fixture. To properly deposit material in the corners, the particle beam is sprayed at an angle. The angle used is identical to the disk shape. This angle can be achieved by either moving the spray gun 101 or the sample. Since the rectangular sample mold 1802 is not rotating, the tilt incorporates an additional dimension. The fill operation, temperature control, and sample cooling are all identical or substantially identical to the disk setup. Depending on the size and shape of the rectangular mold 1802, the compressed air-cooling setup used in the disk setups may be used and adjusted accordingly to provide the temperature control.

Referring to FIG. 19, following material deposition and once the part has cooled to room temperature, the fasteners 1809 can be removed. The walls 1806 can be easily removed from the build plate 1804 as the deposition does not strongly adhere to the mold walls 1806. The compressive stress is relieved once the fasteners 1809 are removed, and the parts easily slide off the deposition walls 1806.

The near-net shape is left attached on the build plate 1804. For large rectangular parts, removing the build plate 1804 can be challenging. A mix of thermal cycling and mechanical force can be used to separate the two components. The coefficient of thermal expansion between the sprayed material and low carbon steel is similar. Therefore, the heat cycling does not always cause immediate delamination.

There may be cases where it may be useful to cut the near-net shaped part 1700 from the build plate 1804. The cutting operation may use electrical discharge machining (EDM), a diamond saw, or a grinding cut-off wheel as these techniques are the most efficient. The core-shell particles may include some ceramic materials that wear high speed steel, carbide, and other typical machining cutters too quickly to be effective machining tools. Additionally, the nature of spray-formed powders such as the ones formed by thermal spray do not machine well with high-speed cutters. These cutters cause the material to fracture rather than cut.

### Extensions to the Embodiments Described Herein

The embodiments described herein may be extended to other powders used in thermal spray processes and may not be limited to strictly core-shell materials. Additionally, other deposition techniques can be used to deposit the powder, for example high velocity oxy-fuel (HVOF) or cold spray or plasma spray can be substituted for the (HVAF) process previously described. The procedures described above can be used to fabricate stator winding cores for hybrid-field motors as well as winding cores for transformers and wireless powder transmission devices that would benefit from 3-dimensional magnetic flow. In addition, the method and apparatus according to the present disclosure may be utilized to produce any applicable components for any suitable applications.

In one example embodiment, a method for spray-forming a component comprises spraying a soft magnetic composite material through a nozzle and into a mold; and adjusting a position of the mold relative to a position of the nozzle to control a deposition of the soft magnetic composite material into the mold. Adjusting the position of the mold relative to a position of the nozzle is carried out with mounting the mold on a stage such that the mold is movable relative to the nozzle and the spraying of the soft magnetic composite material is controlled to provide the deposition of the soft magnetic composite material to form the component in a near-net shape.

Adjusting the position of the mold relative to the position of the nozzle may comprise changing an angle at which the soft magnetic composite material is sprayed relative to the mold. Adjusting the position of the mold relative to the position of the nozzle may comprise moving the mold in at least one of a linear movement or a rotational movement. The method may further comprise controlling a temperature of the soft magnetic composite material during spraying. The method may further comprise cooling at least one of the sprayed magnetic material or the mold. The method may further comprise removing the spray-formed component from the mold. Adjusting a position of the mold relative to a position of the nozzle may comprise operating at least one motor, the operating of the at least one motor being controlled by a controller having at least one processor and at least one non-transitory memory storing instructions that, when executed by the at least one processor, cause the motor to move at least one of the nozzle or the mold.

In another example embodiment, a method for spray-forming a component in a near-net shape comprises providing a system for spraying a soft magnetic material, the system comprising a nozzle; providing a mold for receiving the sprayed soft magnetic material; spraying the soft magnetic composite material through the nozzle and into the mold at a beam spot; adjusting a position of the mold relative to the nozzle to control a deposition of the composite material at the beam spot to form the component in the near-net shape; and removing the component from the mold.

Adjusting the position of the mold relative to the nozzle may comprise moving the mold in at least one of a linear movement or a rotational movement. A rotational speed of the mold and a linear speed of the mold may be coupled such that a velocity of the beam spot during spraying of the soft magnetic composite material is a fixed value with respect to distance per time, and wherein the particle impact speed and temperature is controlled by varying a distance between the beam spot and the nozzle. Adjusting the position of the mold relative to the nozzle may comprise moving the nozzle to direct a spray of the soft magnetic composite material through the nozzle and to the beam spot. Adjusting the position of the mold relative to the position of the nozzle may comprise varying an inclination of an angle at which the soft magnetic composite material is sprayed relative to the mold at the beam spot. Varying the inclination of the angle may comprise spraying the soft magnetic composite material at a first angle on a wall of the mold and spraying the soft magnetic composite material at a second angle on a joint between the wall of the mold and a build plate of the mold. Spraying the soft magnetic material at the second angle on the joint may provide a joint radius that is less than the size of an individual particle of the sprayed soft magnetic composite material. The method may further comprise controlling a temperature of the soft magnetic composite material. The method may further comprise measuring a thickness of the sprayed soft magnetic composite material using a non-contact distance sensor. The method may further comprise pre-heating the mold prior to start of material deposition to allow an expansion of a material of the mold. The nozzle may be used as a source of heat for the pre-heat step. The method may further comprise cooling the mold.

Cooling the mold may be carried out by blowing compressed air from the nozzle onto the mold. Cooling the mold may be carried out by blowing compressed air onto the mold from a secondary source. Cooling the mold may be carried out using an air knife and with controlling one or more of a size of an opening through which the compressed air is blown, a pressure, or a distance from which the opening through which the compressed air is blown. A material of the mold may have a higher thermal expansion coefficient compared to the spray formed material. A surface of the mold may be prepared so its adhesion strength to the component is lower than the strength of the component. Removing the component from the mold may comprise removing a build plate followed by removing a mold wall. A surface hardness of a material of the build plate may be calibrated to enable removal of the component, the calibration being performed through a combination of material selection and grit blasting of a surface of the build plate. The method may further comprise heating the soft composite material using the nozzle.

In another example embodiment, a system for making a component comprises at least one spray gun; a stage mounted proximate the at least one spray gun; and a mold mounted on the stage, wherein the mold is movable relative to the at least one spray gun and is configured to receive a spray of a material in powder form from the at least one spray gun into the mold to deposit a layer of material to form the component in a near-net shape.

The at least one spray gun may be part of a high velocity air fuel system. The at least one spray gun, the stage, and the mold may be in communication with an apparatus comprising, at least one processor, and at least one non-transitory memory storing instructions that, when executed with the at least one processor, cause the apparatus to control at least one movement of the mold relative to the spray gun. At least one of the at least one spray gun and the mold may be movable about at least two independent axes. The mold may comprise a build plate and a wall coupled to the build plate, wherein the wall defines an opening opposite to a surface of the build plate, wherein the opening, the wall, and the surface of the build plate define a cavity for receiving the spray of material. The system may further comprise a second mold coupled concentrically to the mold such that a stepped geometry is produced in the formed component. The build plate and the wall may be fabricated from different materials having different thermal expansion, strength and adhesion properties. The build plate may be fabricated from low carbon steel, and wherein the wall is fabricated from aluminum. The system may further comprise a temperature sensor configured to measure a temperature of at least one of the soft magnetic material sprayed through the at least one spray gun or the mold. The system may further comprise a source of coolant in communication with the mold.

In another example embodiment, an apparatus comprises at least one processor; and at least one non-transitory memory storing instructions that, when executed with the at least one processor, cause the apparatus to spray a soft magnetic composite material through a nozzle and into a mold; and adjust a position of the mold relative to a position of the nozzle to control a deposition of the soft magnetic composite material into the mold. Adjusting the position of the mold relative to a position of the nozzle is carried out with mounting the mold on a stage such that the mold is movable relative to the nozzle and the spraying of the soft magnetic composite material is controlled to provide the deposition of the soft magnetic composite material to form the component in a near-net shape.

In another example embodiment, a motor component comprises a spray formed disk having a first face, an opposing second face, and an edge surface extending between the first face and the opposing second face, wherein a hole having a defining surface extends through the disk from the first face to the opposing second face, and wherein the spray formed disk is formed in a near net manufacturing process.

The hole may be round. The defining surface of the hole may include a stepped surface. The disk may be formed from a soft magnetic composite material comprising domains having a metallic inner portion and a ceramic outer portion. The metallic inner portion may be one of a metal or a ferrous alloy and the outer portion may be alumina. The spray-formed disk may comprise a stator yoke. The spray-formed disk may comprise a portion of an axial flux motor.

Features as described herein may be provided in an apparatus. Features as described herein may be provided in a method of assembly for assembling an apparatus. Features as described herein may be provided in a method of using an apparatus with features as described above. Features as described herein may be provided in control software, embodied in a memory and capable of use with a processor, or controlling an apparatus with movement as described above.

It should be understood that the foregoing description is only illustrative. Various alternatives and modifications can be devised by those skilled in the art. In addition, features from different embodiments described above could be selectively combined into a new embodiment.

What is claimed is:

1. A method for spray-forming a component, the method comprising:
spraying a soft magnetic composite material through a nozzle and into a mold; and
adjusting a position of the mold relative to a position of the nozzle to control a deposition of the soft magnetic composite material into the mold;
wherein adjusting the position of the mold relative to a position of the nozzle is carried out with mounting the mold on a stage such that the mold is movable relative to the nozzle and the spraying of the soft magnetic composite material is controlled to provide the deposition of the soft magnetic composite material to form the component in a near-net shape.

2. The method of claim 1, wherein adjusting the position of the mold relative to the position of the nozzle comprises changing an angle at which the soft magnetic composite material is sprayed relative to the mold.

3. The method of claim 1, wherein adjusting the position of the mold relative to the position of the nozzle comprises moving the mold in at least one of a linear movement or a rotational movement.

4. The method of claim 1, further comprising controlling a temperature of the soft magnetic composite material during spraying.

5. The method of claim 1, further comprising cooling at least one of the sprayed magnetic material or the mold.

6. The method of claim 1, further comprising removing the spray-formed component from the mold.

7. The method of claim 1, wherein adjusting a position of the mold relative to a position of the nozzle comprises operating at least one motor, the operating of the at least one motor being controlled by a controller having at least one processor and at least one non-transitory memory storing instructions that, when executed by the at least one processor, cause the motor to move at least one of the nozzle or the mold.

8. A method for spray-forming a component in a near-net shape, the method comprising:
providing a system for spraying a soft magnetic material, the system comprising a nozzle;
providing a mold for receiving the sprayed soft magnetic material;
spraying the soft magnetic composite material through the nozzle and into the mold at a beam spot;
adjusting a position of the mold relative to the nozzle to control a deposition of the composite material at the beam spot to form the component in the near-net shape; and
removing the component from the mold.

9. The method of claim 8, wherein adjusting the position of the mold relative to the nozzle comprises moving the mold in at least one of a linear movement or a rotational movement.

10. The method of claim 9, wherein a rotational speed of the mold and a linear speed of the mold are coupled such that a velocity of the beam spot during spraying of the soft magnetic composite material is a fixed value with respect to distance per time, and wherein the particle impact speed and temperature is controlled by varying a distance between the beam spot and the nozzle.

11. The method of claim 8, wherein adjusting the position of the mold relative to the nozzle comprises moving the nozzle to direct a spray of the soft magnetic composite material through the nozzle and to the beam spot.

12. The method of claim 8, wherein adjusting the position of the mold relative to the position of the nozzle comprises varying an inclination of an angle at which the soft magnetic composite material is sprayed relative to the mold at the beam spot.

13. The method of claim 12, wherein varying the inclination of the angle comprises spraying the soft magnetic composite material at a first angle on a wall of the mold and spraying the soft magnetic composite material at a second angle on a joint between the wall of the mold and a build plate of the mold.

14. The method of claim 13, wherein spraying the soft magnetic material at the second angle on the joint provides a joint radius that is less than the size of an individual particle of the sprayed soft magnetic composite material.

15. The method of claim 8, further comprising controlling a temperature of the soft magnetic composite material.

16. The method of claim 8, further comprising measuring a thickness of the sprayed soft magnetic composite material using a non-contact distance sensor.

17. The method of claim 8, further comprising pre-heating the mold prior to start of material deposition to allow an expansion of a material of the mold.

18. The method of claim 17, wherein the nozzle is used as a source of heat for the pre-heat step.

19. The method of claim 8, further comprising cooling the mold.

20. The method of claim 19, wherein cooling the mold is carried out by blowing compressed air from the nozzle onto the mold.

21. The method of claim 19, wherein cooling the mold is carried out by blowing compressed air onto the mold from a secondary source.

22. The method of claim 21, wherein cooling the mold is carried out using an air knife and with controlling one or more of a size of an opening through which the compressed air is blown, a pressure, or a distance from which the opening through which the compressed air is blown.

23. The method of claim 22, wherein a material of the mold has a higher thermal expansion coefficient compared to the spray formed material.

24. The method of claim 22, wherein a surface of the mold is prepared so its adhesion strength to the component is lower than the strength of the component.

25. The method of claim 8, wherein removing the component from the mold comprises removing a build plate followed by removing a mold wall.

26. The method of claim 25, wherein a surface hardness of a material of the build plate is calibrated to enable removal of the component, the calibration being performed through a combination of material selection and grit blasting of a surface of the build plate.

27. The method of claim 8, further comprising heating the soft composite material using the nozzle.

28. A system for making a component, the system comprising:
at least one spray gun;
a stage mounted proximate the at least one spray gun; and
a mold mounted on the stage, wherein the mold is movable relative to the at least one spray gun and is configured to receive a spray of a material in powder form from the at least one spray gun into the mold to deposit a layer of material to form the component in a near-net shape.

29. The system of claim 28, wherein the at least one spray gun is part of a high velocity air fuel system.

30. The system of claim 28, wherein the at least one spray gun, the stage, and the mold are in communication with an apparatus comprising,
at least one processor, and
at least one non-transitory memory storing instructions that, when executed with the at least one processor, cause the apparatus to control at least one movement of the mold relative to the spray gun.

31. The system of claim 28, wherein at least one of the at least one spray gun and the mold is movable about at least two independent axes.

32. The system of claim 28, wherein the mold comprises a build plate and a wall coupled to the build plate, wherein the wall defines an opening opposite to a surface of the build plate, wherein the opening, the wall, and the surface of the build plate define a cavity for receiving the spray of material.

33. The system of claim 32, further comprising a second mold coupled concentrically to the mold such that a stepped geometry is produced in the formed component.

34. The system of claim 32, wherein the build plate and the wall are fabricated from different materials having different thermal expansion, strength and adhesion properties.

35. The system of claim 34, wherein the build plate is fabricated from low carbon steel, and wherein the wall is fabricated from aluminum.

36. The system of claim 28, further comprising a temperature sensor configured to measure a temperature of at least one of the soft magnetic material sprayed through the at least one spray gun or the mold.

37. The system of claim 28, further comprising a source of coolant in communication with the mold.

38. An apparatus, comprising:
at least one processor; and
at least one non-transitory memory storing instructions that, when executed with the at least one processor, cause the apparatus to:
spray a soft magnetic composite material through a nozzle and into a mold; and
adjust a position of the mold relative to a position of the nozzle to control a deposition of the soft magnetic composite material into the mold;
wherein adjusting the position of the mold relative to a position of the nozzle is carried out with mounting the mold on a stage such that the mold is movable relative to the nozzle and the spraying of the soft magnetic composite material is controlled to provide the deposition of the soft magnetic composite material to form the component in a near-net shape.

39. A motor component, comprising:
a spray formed disk having a first face, an opposing second face, and an edge surface extending between the first face and the opposing second face, wherein a hole having a defining surface extends through the disk from the first face to the opposing second face, and wherein the spray formed disk is formed in a near net manufacturing process.

40. The motor component of claim 39, wherein the hole is round.

41. The motor component of claim 39, wherein the defining surface of the hole includes a stepped surface.

42. The motor component of claim 39, wherein the disk is formed from a soft magnetic composite material comprising domains having a metallic inner portion and a ceramic outer portion.

43. The motor component of claim 42, wherein the metallic inner portion is one of a metal or a ferrous alloy and the outer portion is alumina.

44. The motor component of claim 39, wherein the spray formed disk comprises a stator yoke.

45. The motor component of claim 39, wherein the spray formed disk comprises a portion of an axial flux motor.
